(19) United States
(12) Patent Application Publication
(10) Pub. No.: US 2007/0262991 A1
(43) Pub. Date: Nov. 15, 2007

(54) Arabic input output method and font model

(76) Inventor: Saad Dean Abulhab, Milford, CT (US)

Correspondence Address: Saad D. Abulhab, 80 Settlers Ridge Road, Milford, CT, 06460, US

(21) Appl. No.: 11/433,863

(22) Filed: May 15, 2006

(51) Int. Cl. G06T 11/00

(52) U.S. Cl. 345/467

(57) ABSTRACT

The new Arabic and extended Arabic font model and associated input/output method of this invention eliminate glyph changes in an Arabetic word processed by computerized systems before users terminate words employing logic stored in a utilized font system. The new method basically introduces different logic within fonts for selecting glyphs to display. Utilizing current smart font technology and Unicode standards with current, or slightly modified, text generation engines, the new font based method is suitable for any font model consisting of two to four glyphs per letter or more including required ligatures. The new method does not require today's commonly used, Arabic specific, Open Type routines, “init”, “medi”, “fina”, or “isol”. The principle goal of this invention is to improve word processing and learning of Arabic and extended Arabic scripts and to establish a more economical, cost effective, Arabetic computing and typography environment.

### BACKGROUND OF THE INVENTION

1. Field of the Invention

The present invention relates to computerized systems utilizing Arabic and “extended Arabic”, hereafter Arabetic, scripts. In particular, the present invention relates to software and hardware computer systems employing dynamic Arabetic characters input/output methods through utilization of fonts or other equivalent glyph depository tools.

2. The Prior Art

Traditional Arabetic scripts are typically generated on today's computerized systems using a Unicode based font model that represent each letter with two to four different shapes (glyphs) depending on the location of that letter within a word. These glyphs are referred to as “initial”, “medial”, “final”, and “isolated” form glyphs. They represent letters shapes when displayed in the beginning, middle, final, or isolated locations within a word, respectively. A letter unique Unicode value is always assigned to its “Isolated” shape glyph within this font model. Since most Arabetic letters are displayed connected from both sides, these letters are represented by four glyphs per letter. A smaller number of the Arabetic letters must always appear isolated or connected from one side and are therefore represented by one or two glyphs per letter. We refer to these letters as “isolate trigger” letters in this invention.

Present time Arabetic text input/output method utilizes font software and model that typically contain all of the position dependent glyphs above and must also include the required logic or input/output method to manage their selections and substitutions. The current method commonly uses Open Type tables and four “features” corresponding to Arabic specific application software routines, “init”, “fina” “medi” and “isol”, to process glyphs for initial, medial, final, and isolated shape formations respectively. This technology is usually incorporated in a suitable text generation software engine. Still, other Arabetic font models may only contain glyphs for various shape segments that can be handled dynamically to generate the above desired location dependent letter glyphs without using Open Type font technology but other alternative logic.

Referring to FIG. 1 which illustrate current shaping method in action through generation of two example words, and regardless of how current input/output methods generate desired glyphs, these glyphs are displayed in the following manner: first glyph is always displayed in its “isolated” form initially, after a second letter is keyed, the first letter changes to its “initial” shape while the second letter is displayed in its “final” shape. When user keys in a third letter, the second letter is displayed in its “medial” shape while the third letter is displayed in its “final” shape. Exceptions to this general scheme apply if letters being keyed or letters preceding them are “isolate trigger” letters. In other words, a letter is always displayed in its “isolated” form first, but in the overwhelming cases, at least one dynamic glyph substitution, or shape changing, is performed after each subsequent letter keyed. This described process above is referred to today as “shaping” or “glyph substitution” process. Both font software and host applications software must include the logic necessary for this input/output method to work. Typically and due to the complex nature of the problem of handling Arabetic scripts on computerized systems, the solutions employed can be costly and time consuming. But most importantly the user side details of the common methods contradict with the way Arabetic scripts are written or learned naturally which consequently present obstacles for users and learners of these scripts.

U.S. Pat. No. 4,176,974 to Bishai discloses an input/output method for video display and editing of Arabic text utilizing today's commonly used full glyph substitution approach, with a text and editing look and feel significantly different from the one resulting from this new invention.

U.S. Pat. No. 4,670,842 to Metwaly discloses a method to display Arabic characters in a natural way utilizing minimal glyph substitution, with a text and editing look and feel similar to the one resulting from the method of this new invention but the software logic routines, and letter sets employed are different and are built into system and software application, not font software based as in the new invention. Additionally, the disclosed method is complicated, costly, and most importantly not conformant with or transparent to current font based Unicode standards and technology.

U.S. Pat. No. 6,704,116 to Abulhab discloses a font model wherein each letter is assigned one glyph only, designed in a special manner, to initiate a linear input/output method where no glyphs substitutions take place.

U.S. Pat. No. 6,799,914 B2 to Yoon-Hyoung Eo discloses an Arabic-Persian input method where letters are keyed using a minimal number of character segments to construct corresponding Arabic-Persian letters stored in a back end database. On a typical word processing application, this method is not user or education friendly in addition to being not conformant with Arabic typography and computing technology standards.

Accordingly, it would be desirable to provide an input/output method matching as close as possible the actual and natural way Arabetic scripts users write and visualize words, a font based method that is, at the same time, independent of and transparent to software applications and conformant to currently employed font and Unicode standards.

### BRIEF SUMMARY OF THE INVENTION

It is a principle object of this invention to provide an option to input Arabetic scripts on computerized systems in a manner closely related to how users actually write and learn these scripts. The new input/output method employed in this invention to minimize glyph substitutions produces a more suitable environment for Arabetic educational and text editing purposes but at the same time is a more cost effect environment for software and typography development. Briefly, the new method eliminates glyph changes in an Arabetic word before users terminate words employing new logic stored in a utilized font. The new method basically introduces different logic for selecting glyphs to display. Utilizing current smart font technology and Unicode standards with current, or slightly modified, text generation engines, the new font based input/output method and font model of this new invention are suitable for any font glyph model consisting of two to four glyphs per letter or more including required ligatures.

### BRIEF DESCRIPTION OF THE DRAWINGS

FIG. 1 illustrates how prior art or current typical input/output method utilizing four glyphs per letter Arabic font model processes and displays two sample Arabic words, one with “isolate trigger” letters present and one without.

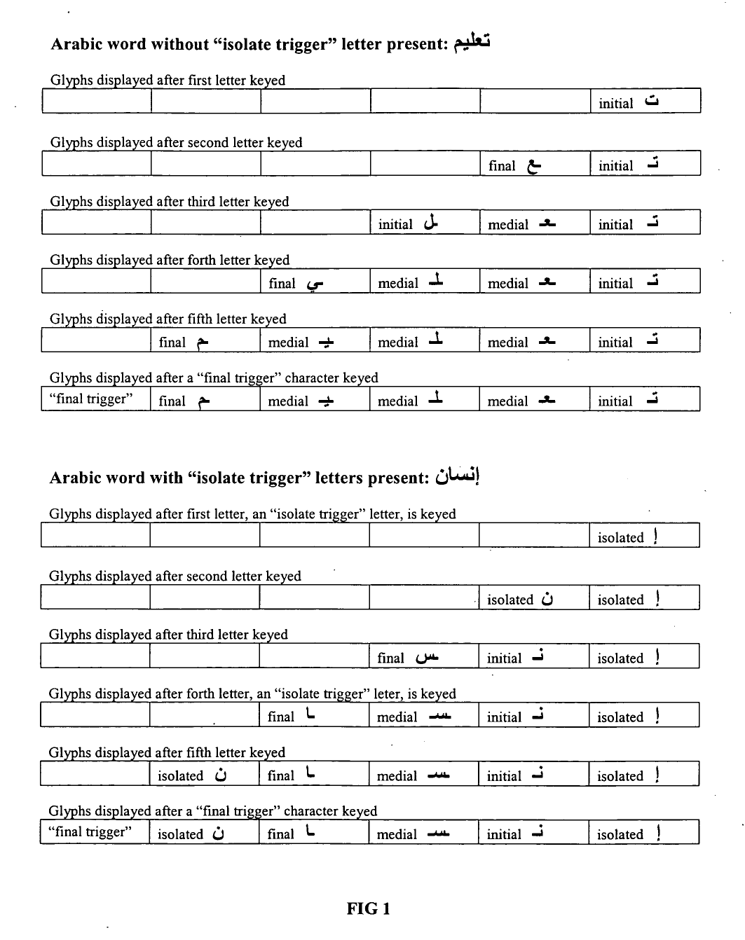

FIG. 2 shows two tables illustrating how present invention input/output method utilizing four glyphs per letter Arabic font model select or change glyph shapes based on prior letter and following character keyed within an Arabetic word in a manner compatible with current smart font technology and Unicode standards.

FIG. 3 shows a block diagram of the present invention input/output method utilizing four glyphs per letter Arabic font model.

FIG. 4 illustrates how the present invention input/output method utilizing four glyphs per letter Arabic font model processes and displays two sample Arabic words, one with “isolate trigger” letters present and one without.

FIG. 5 shows two tables illustrating how the present invention input/output method utilizing two glyphs per letter Arabic font model select or change glyph shapes based on prior letter and following character keyed within an Arabetic word in a manner compatible with current smart font technology and Unicode standards.

FIG. 6 shows a block diagram of the present invention input/output method utilizing two glyphs per letter Arabic font model.

FIG. 7 illustrates how the present invention input/output method utilizing two glyphs per letter Arabic font model processes and displays two sample Arabic words, one with “isolate trigger” letters present and one without.

### DETAILED DESCRIPTION OF THE INVENTION

Today's most commonly used glyph substitutions method, or shaping, is an input/output method created specifically with Arabetic computerized systems in mind. Earlier typewriters handled Arabetic scripts in the same static manner as natural writing. Needless to say that users of today's computerized systems have to adjust significantly to get used to this method's dynamic glyph changing approach. Editing text with this current method is annoying and time consuming but most importantly teaching Arabetic scripts via computers employing such method can also be difficult and discouraging. Learners are overwhelmed by the many shapes to learn at once. The final text outcome combining glyphs of this currently used font model and input/output method is generally consistent with the way Arabetic scripts appear when printed or written but is not consistent with the actual and natural way users are taught how to write and visualize Arabetic letters. When users actually write an Arabetic word on paper or other mediums, they know or mentally visualize in advance what location dependent shape to choose and draw next in order to form a word. By presenting letters always in their “isolated” or “final” shapes, the current method deprives users from sufficient exposure to “initial” and “medial” forms. Learners of Arabetic scripts have to struggle on their own to distinguish them from other connected shapes.

This invention introduces a new font model and associated input/output process logic or method, conformant with Open Type and Unicode standards, to display letters in a manner closely tied to the natural way users experience them in writing. The new input/output method can work with multiple glyphs per letter models including two glyphs per letter and four glyphs per letter font models. The new font model is similar to current font models regarding variable glyphs per letters representations, except that unlike current approach, the new invention method assigns “initial” shapes, not “isolated” shapes, to a font basic Unicode values so that letters are always displayed in their initial form first, as they naturally do when users begin writing words. Additionally, the new font model does not require the use of Arabic specific Open Type “features” but instead uses a single general purpose conditional substitution “feature”.

This invention classifies Arabetic letters in two categories or sets. An “isolate trigger” letter set which include all Arabetic letters that can not connect simultaneously on both sides to other letters within word. Arabic Hamzah which is always isolated within words is therefore included in this set. And a non “isolate trigger” set including the remaining letters that can connect simultaneously on both sides. As of the current Unicode standards “isolate trigger” letters are then specifically letters with the following Unicode values: 0622 0623 0624 0625 0627 062F 0630 0631 0632 0648 0671 0672 0673 0675 0676 0677 0688 0689 068A 068B 068C 068D 068E 068F 0690 0691 0692 0693 0694 0695 0696 0697 0698 0699 06EF 06EE 06CF 06C4 06C5 06C6 06C7 06C8 06C9 06CA 06CB 0621 0629 0674 06BA 06D5. Diacritic vowel marks are not included in either set. In a two glyphs per letter font model, letters belonging to the “isolate trigger” set are always represented by one glyph, “initial”, while letters belonging to the non “isolate trigger” set are represented by two glyphs, “initial” and “final”. In a four glyphs per letter representations, letters belonging to the “isolate trigger” set are represented by two glyphs, “initial”, and “final”, while letters belonging to the non “isolate trigger” set are represented by four glyphs, “initial”, “medial”, “final”, and “isolated”.

Recall from the brief description section of this invention method that glyph substitutions are being eliminated while a user is still editing a word. A word is defied here as any Arabetic word containing one or more Arabetic letters plus any additional diacritic marks or vowels. The end of a word is triggered according to the present invention when a character member of a “final trigger” set is explicitly keyed by user or invoked automatically by the system or text processing engine. The “final trigger” character set includes for example, space, tab, period, colon, comma, numbers, or even an “invisible” characters like the “Zero Width Space” character. Members of this set are all non Arabetic letters and vowel diacritic marks in a font and Arabetic letters always appear isolated, like Arabic “Hamza”.

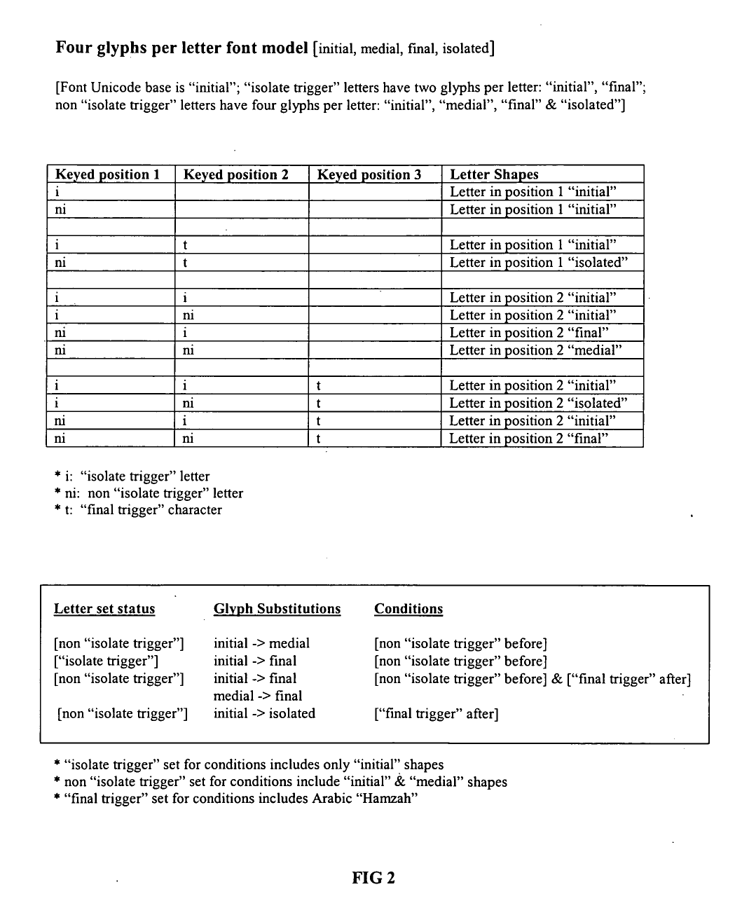

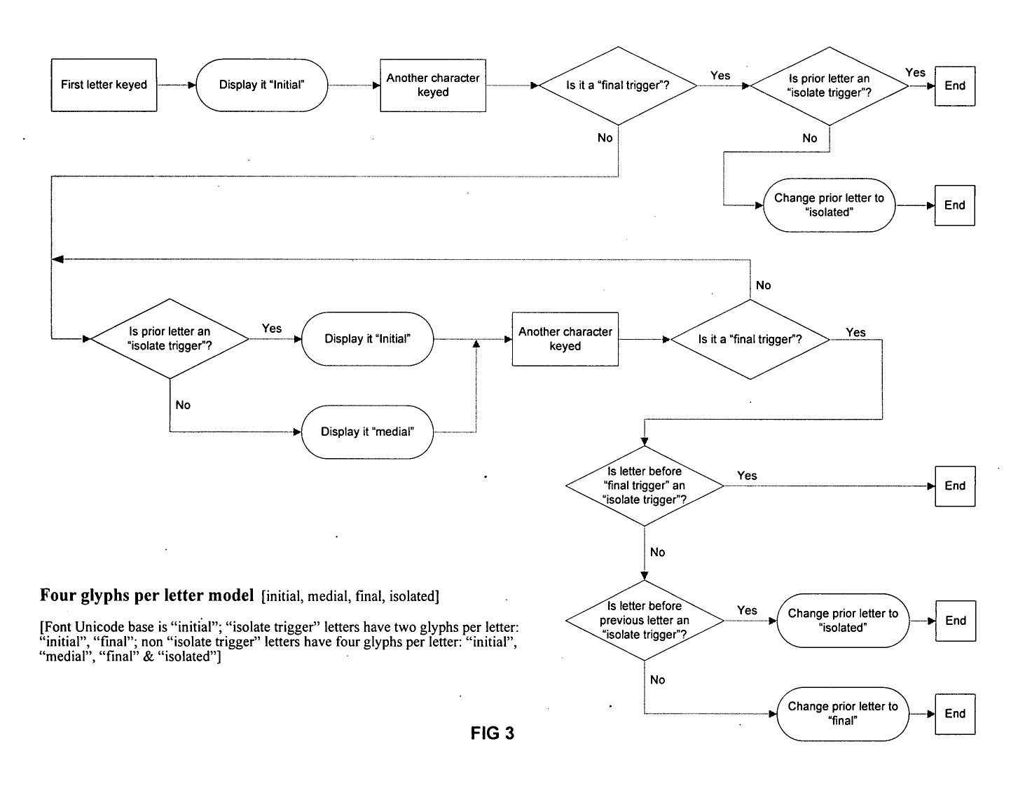

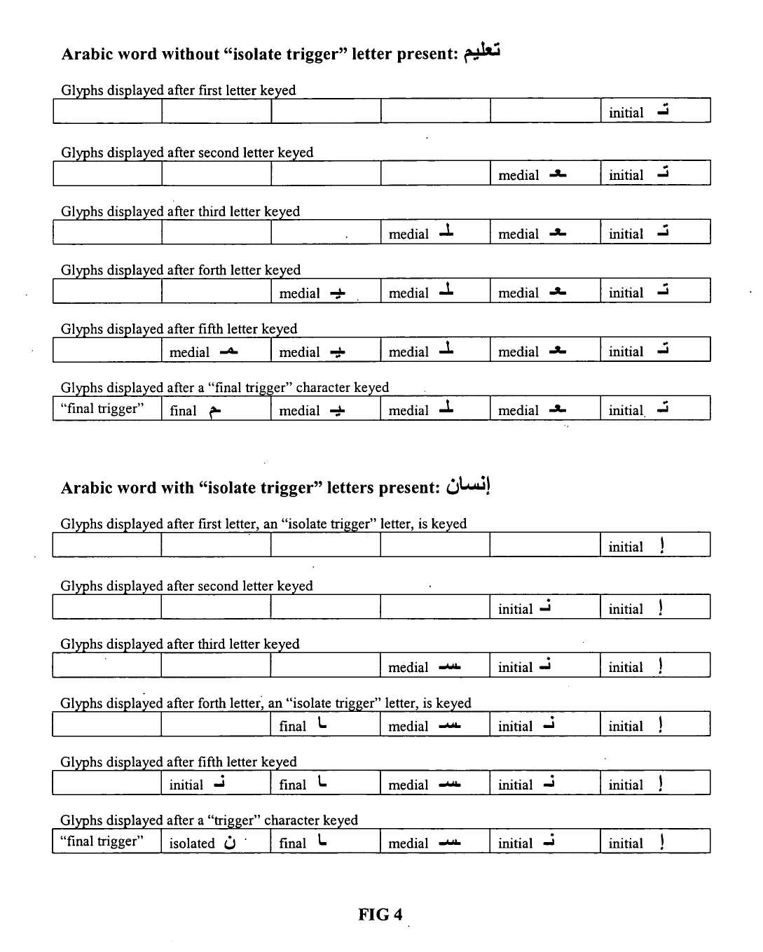

Referring to FIG. 2, FIG. 3, and FIG. 4, according the new input/output method, in a four glyphs per letter font model where letters are generally represented by four glyphs or shapes: “initial”, “medial”, “final”, and “isolated”, first letters keyed are always displayed in there “initial form”. If a “final trigger” character is keyed after, first letter would change to “isolated” form only if it is not a member of the “isolate trigger” letters set since an “isolate trigger” letter “initial” shape is at the same time its “isolated” shape and therefore does not need to change. If another letter is keyed after first letter, it will be displayed in its “medial” shape if both the previous letter and the letter itself are not members of the “isolate trigger” letters set including both “initial” and “medial” forms. If previous letter is an “isolate trigger” letter, then current letter is always displayed in its “initial” shape. If previous letter is not an “isolate trigger” letter and current letter is, current letter is displayed in its “final” form. This process will repeat for as many letters in a word until a “final trigger” character is keyed. In such case, if last letter keyed is an “isolate trigger” letter, then no change is needed and the process ends. If last letter keyed and the letter before are not an “isolate trigger” letter, then last letter changes to “final” shape. If last letter keyed is not an “isolate trigger” and the letter before is an “isolate trigger”, then last letter changes to “isolated” shape. The second table of FIG. 2 demonstrates the four logic operations needed to accomplish the behavior outlined above. In the first one, all “initial” shapes of a non “isolate trigger” set are to be displayed in their “medial” shape when letters from a non “isolate trigger” set, including “initial” and “medial” forms, are keyed before. In the second one, all “initial” shapes of an “isolate trigger” set are to be displayed in their “final” shape when letters from a non “isolate trigger” set, including “initial” and “medial” forms, are keyed before. In the third one, all “initial” and “medial” shapes of a non “isolate trigger” set are to be displayed in their “final” shape when letters from a non “isolate trigger” set, including “initial” and “medial” forms, are keyed before and a characters from the “final trigger” set are keyed after. Finally, in the fourth one, all “initial” shapes of a non “isolate trigger” set are to be displayed in their “isolated” shape whenever characters from the “final trigger” set are keyed with no other conditions applied. The logic of this new input/output method is based on assigning “initial” shapes to basic Unicode values as explained earlier.

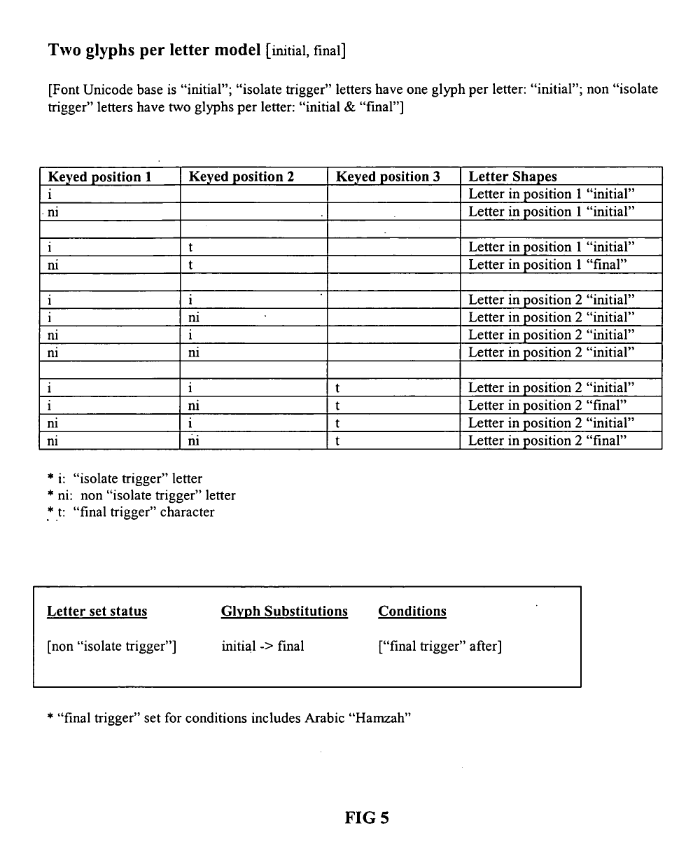

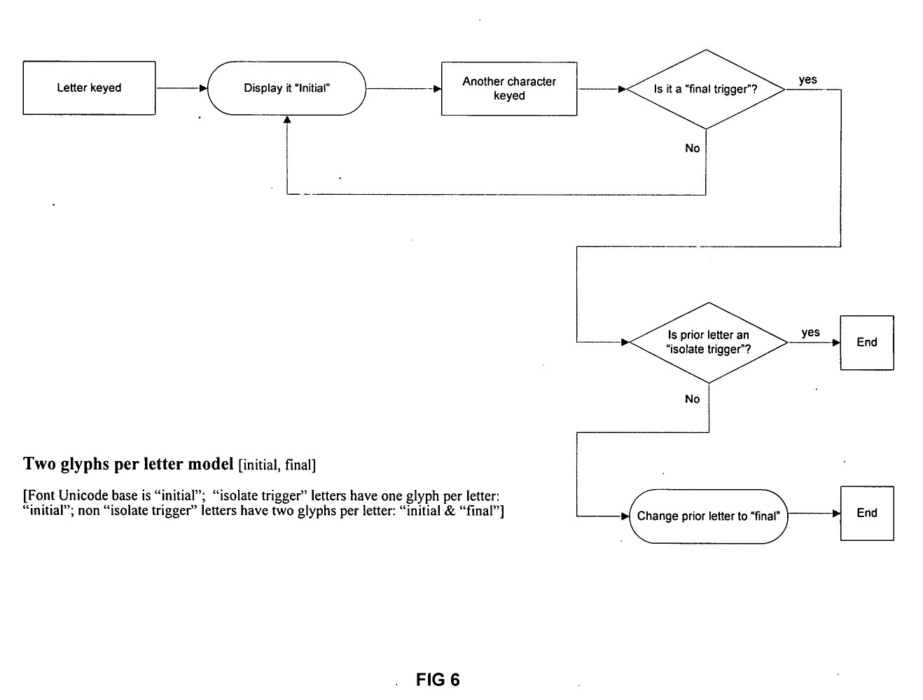

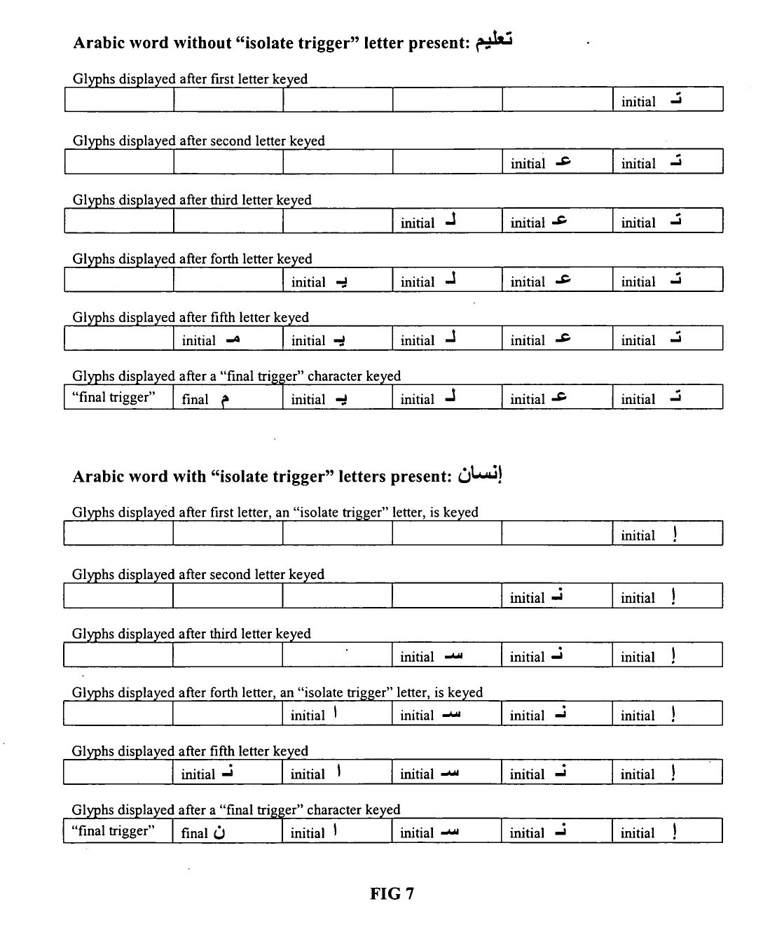

Referring to FIG. 5, FIG. 6, and FIG. 7, according to the new input/output method in a two glyphs per letter font model where all “isolate trigger” letters are assigned one shape per letter, “initial”, and other letters are represented by two glyphs or shape per letter, “initial” and “final”, all letters keyed are always displayed in their initial shape, until a “final trigger” character is keyed, in which case a letter would change to its “final” form if it was not an “isolate trigger” letter. An “isolate trigger” letter would stay the same all the time. The second table of FIG. 5 demonstrates the only logic operation needed to accomplish the behavior outlined above. In this operation, all “initial” shapes of a non “isolate trigger” set are to be displayed in their “final” shape whenever characters from the “final trigger” set are keyed. Again, the logic of this new input/output method is based on assigning “initial” shapes to basic Unicode values.

In both font models above, the new invention employs one logical operation within a font selecting or replacing glyphs based on the type of letter being keyed, the type of letter already keyed before, or the type of character keyed following a keyed letter. The type of a letter is determined by checking whether that letter is a member of the “isolate trigger” set or not. The type of character is determined by checking if that character is a member of “final trigger” set or not. This logical operation in a typical Open Type font environment would be the simple, commonly used, “calt” feature, which can replace or select glyphs based on contextual conditions. As a result, utilizing this invention method and font model would not require the use of Open Type Arabic specific features, “init”, “fina”, “medi”, and “isol”, which can simplify both complex text processing engines and Arabetic font design and creation.

With the exception of the “Lam-Alif” ligature, the scope of this new invention treats ligatures resulting from combining two or more letters in one glyph or shape as calligraphic or typographic variations that do not require the elimination of glyph substitution. Since for teaching or text editing purposes it is not required to hide the glyph substitution taking place by ligature forming. But the required “Lam-Alif” ligature, according to this invention, can be keyed on the keyboard level to avoid glyph substations prior to word termination if desired.

In both font models above and other multiple glyphs per letter models when including required ligatures, the new invention font based input/output method and the utilized new font model will ensure an absolute minimal glyph substitutions taking place prior to word termination. The elimination of glyph changing after each key stroke will improve the learning curve of Arabetic scripts and simplifies their editing in a word processing environment. The inclusion of this method on the font level allows users more control on the choice of and the look and feel of text and text editing since users can change fonts easily in most applications.

As for vowel diacritic marks, the method of this invention does not include them in any logic operation involving selections of letters glyphs. In a typical font model today they are transparent and are usually associated with letters. But, if they do not behave in that manner for any reason, they can easily be treated as independent letters and be included in the logic of the new method to accomplish the same desired outcome.

The new input/output method of this new invention was created and tested with two and four glyphs per letter font models utilizing a JAVA applet as prototype text editing engine and Open Type fonts performing multiple “calt” Open Type “feature” logic executions.

1. An Arabic and extended Arabic, hereafter Arabic, font model and associated font based input/output method or system utilizing said font model, comprising the steps of:
A. creating said font to contain optional multiple shapes per Arabic letter depending on letter location within traditional multiple-letters Arabic words, including a mandatory “initial” shape, wherein unique Arabic basic Unicode values are assigned to said font's “initial” shapes to the effect that said shape is the default Arabic letter shape supplied to the input/output system to be processed;
B. creating a “final trigger” characters set to contain all characters in said font signaling termination of Arabic words consisting of one or more letters, wherein said set can include any or all character(s) in said font, excluding Arabic letters and diacritic vowel marks except for letters that must always appear isolated within traditional multiple-letters Arabic words;
C. grouping all Arabic letters in said font, excluding vowel diacritic marks, into two distinctive sets of letters, an “isolate trigger” letters set comprising letters that can not connect simultaneously with other letters from two sides within traditional multiple-letters Arabic words, and a non “isolate trigger” letters set comprising letters that can connect simultaneously with other letters from two sides within traditional multiple-letters Arabic words, wherein letter shapes included in the non “isolate trigger” set are determined by the number of shapes per letter of said font model; and
D. executing conditional logic operations implemented within said font and associated method system to select or substitute desired glyphs depending on the “isolate trigger” set membership status of a letter being keyed and the letter keyed before it, or depending on the “isolate trigger” set membership status of a letter being keyed and the letter keyed before it and the “final trigger” set membership status of the character keyed after it, or depending on the “isolate trigger” set membership status of a letter being keyed and the “final trigger” set membership status of the character keyed after it.

2. An input/output method or system according to claim 1 displaying or outputting distinctive, not changing before word termination, Arabic letters shapes to form words wherein first letter is initially displayed in a unique “initial” default shape and following letters may be displayed in any one of their multiple shapes depending first on the number of these shapes, and depending second on the letter currently input, and the letter directly preceding it, until word is terminated, in such case the shape of the last letter in a word may be substituted by a different shape depending first on the number of shapes per letter, and depending second on the letter currently input.

3. An input/output method or system according to claim 1 and as illustrated in FIG. 2, FIG. 3, and FIG. 5, utilizing four shapes per letter Arabic font model wherein each Arabic letter have one default “initial” shape assigned to its corresponding unique Arabic basic Unicode value, and up to three additional in-word position-dependent shapes, “medial”, “final”, or “isolated”, displaying or outputting distinctive, not changing before word termination, Arabic letters shapes to form words, wherein first letter is initially displayed in “initial” shape, following letters, if members of “isolate trigger” set, are displayed in their “isolated” or “final” shapes otherwise are displayed in their “initial” or “medial” shapes, depending on membership status in “isolate trigger” set including both “initial” and “medial” shapes, of the letter currently being input and the letter directly preceding it, until word is terminated, in such case the shape of the last letter in said word may be substituted by either “final” or “isolated” shapes depending on membership status in said “isolate trigger” set of the letter currently input.

4. An input/output method or system according to claim 1 as illustrated in FIG. 5, FIG. 6, and FIG. 7 utilizing two shapes per letter Arabic font model wherein each Arabic letter have one default “initial” shape assigned to its corresponding unique Arabic basic Unicode value, and up to one additional shape, “final”, displaying or outputting distinctive Arabic letters shapes to form words wherein all letters are always displayed in their “initial” shape, until a word is terminated, in such case the shape of the last letter in said word will be substituted by its “final” shape only if that letter was a member the “isolate trigger” set.

5. An input/output method or system according to claim 1 wherein word termination logic is executed, when a character from the “final trigger” set is keyed or inserted, utilizing direct user selection, or automatic system intervention alone, or both.

6. An input/output method or system according to claim 1 wherein vowel diacritic marks are either associated with individual letters and are therefore transparent to and excluded from the executed logic of the new method, or treated as regular Arabic letters and are therefore incorporated in the executed logic of the new method as logic conditions associated with the insertion of a “final trigger” set character.

7. An input/output method or system according to claim 1 wherein glyph substitutions are still minimal and are eliminated before word terminations when required “ligatures”, as in the “Lam-Alif” ligature, are processed.

8. An input/output method or system according to claim 1 wherein glyph substitutions are still minimal but not eliminated before word termination when optional “ligatures” are processed.

9. An input/output method or system according to claim 1 wherein employing complex, Arabic specific, Open Type features, “isol”, “init”, medi”, or “fina”, along with text generation engine software logic routines implementing them, are not required to process multiple glyphs per letter font models.

10. An input/output method or system according to claim 1 when utilized for educational or text editing purposes by learners and users, a significant learning curve reduction and text editing efficiency would be realized.

11. An input/output method or system according to claim 5 wherein user selection is implemented by user selecting font or other system module containing, partially or entirely, said word termination logic and execution instructions.

12. An input/output method or system according to claim 5 wherein utilizing automated system intervention alone to execute word termination logic, by default or not, creates a font-independent input/output method, wherein said automated system intervention processes are executed entirely by system, regardless of font model including choice of mandatory shape assigned to basic Unicode values as outlined in claim 1 step A, and wherein such automated processes may include permanent or temporary insertions of a system accessed character from the “final trigger” set, as way of intervention, to override the display of words' end or terminating default letters shapes, or to output desired ones.

13. A font-independent input/output method or system according to claim 3 or claim 4, and claim 12, utilizing a Unicode standards compliant Arabic font and text area environment, wherein the mandatory shape assignment to unique Arabic basic Unicode values is either “final”, “initial”, or “isolated”, and wherein Unicode character ZERO WIDTH JOINER, 200D, being a system accessed character of the “final trigger” set, is temporarily inserted at words' end or termination, to override default letters “final” or “isolated” shapes to output “medial” or “initial” shapes instead.

14. An input/output method or system according to claim 5 and claim 12 wherein both user selection and automatic system intervention alone are utilized to execute word termination logic, but wherein said execution is only triggered by user selection not by default.
